(19) United States
(12) Patent Application Publication
(10) Pub. No.: US 2012/0278158 A1
(43) Pub. Date: Nov. 1, 2012

(54) NATURAL EXPERIMENTS IN ONLINE ADVERTISING

(75) Inventor: Ayman Farahat, San Francisco, CA (US)

(73) Assignee: Yahoo! Inc., Sunnyvale, CA (US)

(21) Appl. No.: 13/096,867

(22) Filed: Apr. 28, 2011

(51) Int. Cl. G06Q 30/00

(52) U.S. Cl. 705/14.41

(57) ABSTRACT

The present invention provides techniques which can be viewed as natural experiments in online advertising. Techniques are provided in which online advertising information is used in obtaining experimental information for measuring or estimating an impact of a variable such as a user-advertisement relationship, such as advertisement targeting, on performance of an advertisement, such as may be measured using conversation rates, click through rates, or other metrics. Techniques are provided that include use of a difference-in-differences technique, including use of performance information relating to performance of two different advertisements relative to a treatment group and a control group.

### BACKGROUND

Advertisers, including online advertisers, are demanding more accurate estimates of the impact of targeted ads. A general approach for estimating the impact of targeted ads has been to design an experiment. For example, the ad is shown to a broad range of users; the users who match the targeting criteria are the treatment group and the users who do not match the targeting are the control group. The impact of targeting is then measured or estimated to be the difference in the conversion rates between the treatment and control group.

There are shortcoming of the above approach, however. The goal may be to measure or estimate the impact of targeting on ad performance, such as an associated conversion rate, as one metric. This may amount to asking, what is the difference in conversion rate between targeted users who viewed the ad and untargeted users who have viewed the ad? In order to measure or estimate this difference, one may need to show the user a targeted and untargeted ad. Showing the user targeted and un-targeted ad may be akin to the before and after analysis used in estimating treatment effect. However, it may not be enough or be optimized to just compute the “before” and “after” difference on a test group, because there could be many other factors that have changed between the “before” and “after.” As one example, if the “after” ad (targeted), was visually more appealing than the “before” Ad (un-targeted), then the “before” and “after” difference may tend to overestimate the impact of targeted ads.

There is a need for improved techniques for use in measuring or estimating advertisement performance such as online advertisement performance, or measuring or estimating effects or impacts of factors or variables in advertisement performance.

### SUMMARY

Some embodiments of the invention provide systems and methods which may be viewed as natural experiments in online advertising. Techniques are provided in which online advertising information is used in obtaining experimental information for measuring or estimating an impact of a variable such as a user-advertisement relationship, such as advertisement targeting, on performance of an advertisement, such as may be measured using conversation rates, click through rates, or other metrics. Techniques are provided that include use of a difference-in-differences technique, including use of performance information relating to performance of two different advertisements relative to a treatment group and a control group.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

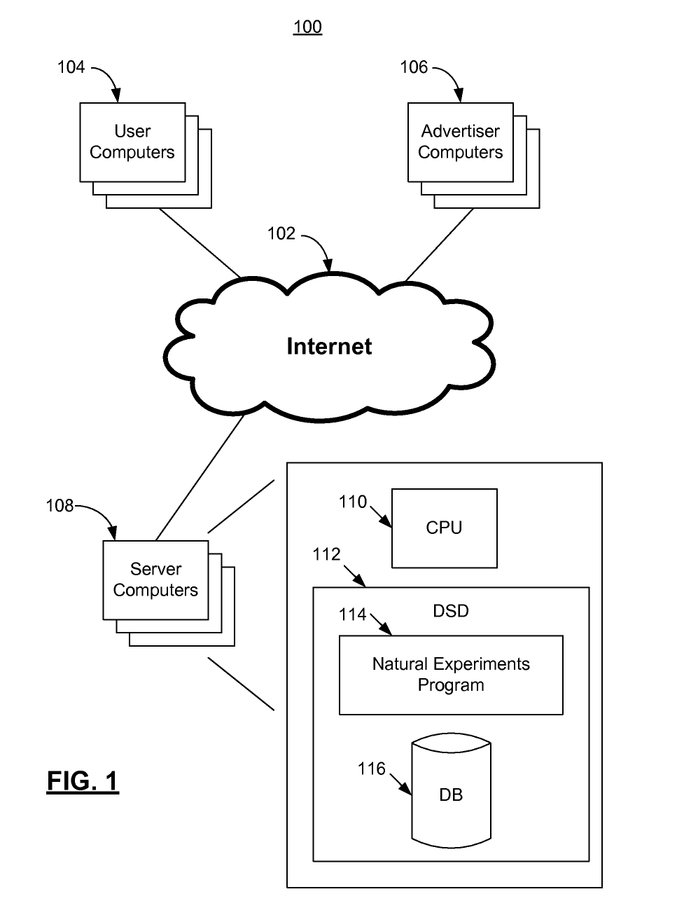

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Natural Experiments Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

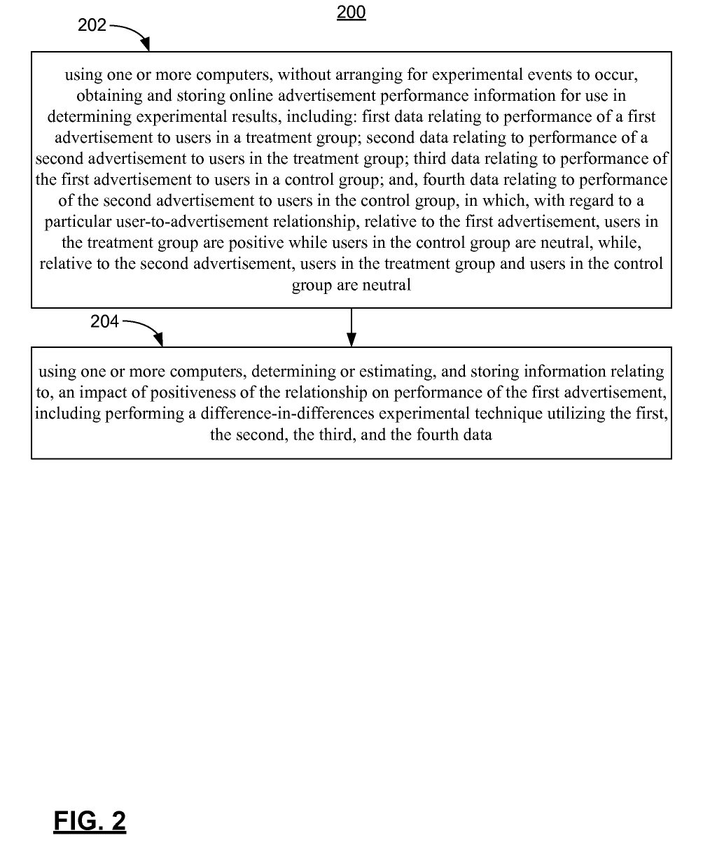

FIG. 2 is a flow diagram illustrating a method 200 according to one embodiment of the invention. Step 202 includes, using one or more computers, without arranging for experimental events to occur, obtaining and storing online advertisement performance information for use in determining experimental results. The advertisement performance information includes: first data relating to performance of a first advertisement to users in a treatment group; second data relating to performance of a second advertisement to users in the treatment group; third data relating to performance of the first advertisement to users in a control group; and, fourth data relating to performance of the second advertisement to users in the control group. With regard to a particular user-to-advertisement relationship, relative to the first advertisement, users in the treatment group are positive while users in the control group are neutral, while, relative to the second advertisement, users in the treatment group and users in the control group are neutral.

Step 204 includes, using one or more computers, determining or estimating, and storing, information relating to, an impact of positiveness of the relationship on performance of the first advertisement, including performing a difference-in-differences experimental technique utilizing the first, the second, the third, and the fourth sets of information.

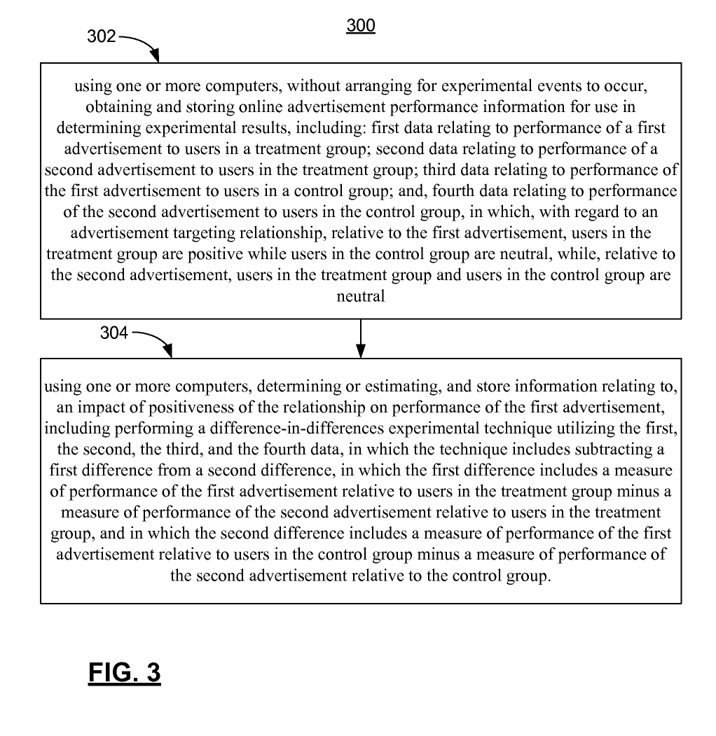

FIG. 3 is a flow diagram illustrating a method 300 according to one embodiment of the invention. Step 302 is similar to step 202 of the method 200 depicted in FIG. 2.

Step 304 includes, using one or more computers, determine or estimate, and store information relating to, an impact of positiveness of the relationship on performance of the first advertisement, including performing a difference-in-differences experimental technique utilizing the first, the second, the third, and the fourth sets of information. The technique includes subtracting a first difference from a second difference, in which the first difference includes a measure of performance of the first advertisement relative to users in the treatment group minus a measure of performance of the second advertisement relative to users in the treatment group, and in which the second difference includes a measure of performance of the first advertisement relative to users in the control group minus a measure of performance of the second advertisement relative to the control group.

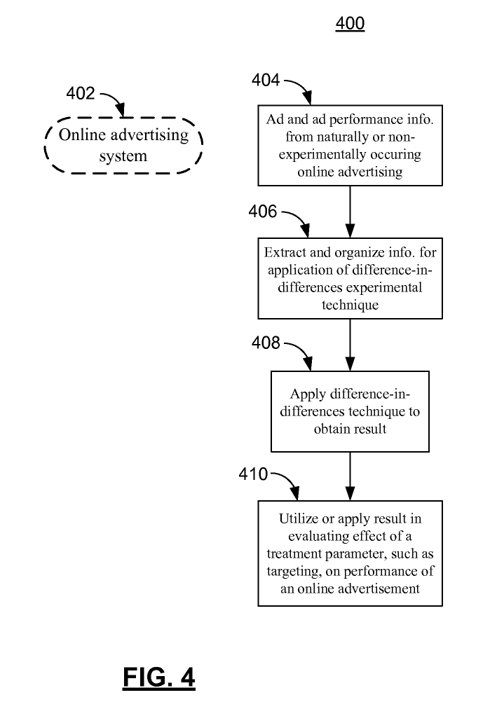

FIG. 4 is a block diagram 400 illustrating one embodiment of the invention. Block 402 represents an online advertising system.

Block 404 represents information which may be obtained from or derived from the online advertising system 402, including ad and ad performance information from naturally or non-experimentally occurring online advertising, which may include various information such as targeting information, user information, etc.

Block 406 represents extraction and organization of information obtained at block 404, for application of a difference-in-differences experimental technique.

Block 408 represents application of a difference-in-differences technique to obtain result information.

Block 410 represents utilization of, or application of, result information in evaluating effect of a treatment parameter or variable, such as targeting, on performance of an online advertisement.

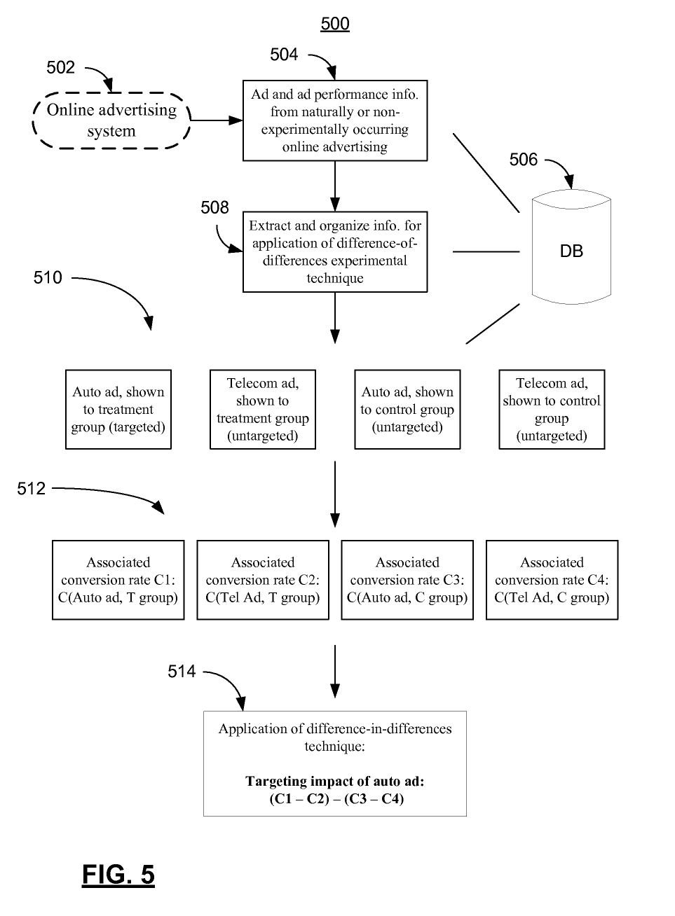

FIG. 5 is a block diagram 500 illustrating one embodiment of the invention. Block 502 represents an online advertising system. Various information from the various blocks may be stored in one or more databases 506.

Block 504 represents ad and ad performance information, obtained or derived from the online advertising system 502, from naturally or non-experimentally occurring online advertising.

Block 508 represents extraction and organization of information, from Block 504, for application of difference-in-differences experimental technique.

Block 510 represents groups of information of the information of block 508, including: information regarding an automobile ad, or auto ad, shown to a treatment group; information regarding a telecommunications ad, or telecom ad, shown to the treatment group; information regarding the auto ad shown to a control group; and, information regarding the telecom ad shown to the control group. The auto ad is targeted to the treatment group, but the telecom ad is not targeted to the treatment group. The telecom ad is not targeted to the treatment group and is not targeted to the control group.

Block 512 represents conversion rates associated with each of the groups indicated at block 510, including associated conversion rate C1, which represents C(auto ad, treatment group), associated conversion rate C2, which represents C(telecom ad, treatment group), associated conversion rate C3, which represents C(auto ad, control group), and, associated conversion rate C4, which represents C(telecom ad, control group).

Block 514 represents application of a difference-in-differences experimental technique, in which impact of targeting of the auto ad is measured or estimating by or using the result of:

(C1−C2)−(C3−C4) (Eq. 1)

Some embodiments of the invention include techniques for measuring or estimating the impact, or causal impact, of targeting, using natural experiments.

Some embodiments include using a difference-in-differences experimental technique utilizing non-experimental or naturally occurring ad system and ad performance related information. For example, some embodiments include showing a treatment group both targeted (Adtargeted) and untargeted ads (Aduntargeted). During the same time period, ads are shown to a control group that do not match the targeting criteria for either Adtargeted or Aduntargeted. The difference between the conversion rates can provide a measurement or estimate of the factors other than targeting that could have impacted conversion, for example, creative ad design, etc.

As an example according to one embodiment, let Con_test_Adtargeted, Con_test_AdUntargeted denote the conversion rates on test group of Adtargeted, AdUntargeted respectively. Let Con_control_Adtargeted, Con_control_AdUntargeted denote the conversion rates on control group of Adtargeted, AdUntargeted respectively. The impact of targeting may then be measured or estimated utilizing or by

Targeting=(Con_test_Adtargeted−Con_test_AdUntargeted)−(Con_control_Adtargeted−Con_control_AdUntargeted) (Eq. 2)

For example, an Internet portal's home or front page ads may be sold as “roadblocks,” where all visitors to the page on a specific date are shown ads from one exclusive advertiser, or as “splits,” where an advertiser purchases all display ad impressions delivered to visitors that arrive on an even second or an odd second. The front page ad server ignores the identity of the user when deciding which ad to serve. Provided users ignore whether their visit occurs on an even or an odd second, ad delivery may be essentially a coin toss on “split” days and, hence, varies exogenously.

Continuing the example, this randomness of individuals' arrival time can allow measurement of the effect of targeting on days where two advertisers each purchase a “split.” On these days, for instance, individuals who visit the front page ten times see between zero and ten impressions from the “even-second” advertiser and the complement of ten from the “odd-second” advertiser. Furthermore, each of the advertisers will have a target audience, for example users who are in the behavioral targeting (BT) group or segment that the advertiser normally targets. Consequently, users in the BT segment of say “even-second” advertiser will get exposed to both targeted Ads during the even seconds and untargeted Ads during the odd seconds. Users who do not belong to the BT segments of either the “even-second” or the “odd-second” advertiser are the control group.

The foregoing can provide the information for a natural experiment. A difference-in-differences estimator to measure the impact of the targeting, as indicated by Equation 2, above.

For example, assume, on a front page split, ads are shown from each of two advertisers, automobile advertiser (auto) and telecommunications advertiser (telco). Steps can include the following. Get the response rate of the telco ad on an auto BT group, Con_test_AdUntargeted. Next, get the response rate of the auto ad on an auto BT group, Con_test_Adtargeted. Next, get the response rate of the auto ad on users who are not in a BT group of either the auto ad or the telco ad, Con_control_Adtargeted. Next, get the response rate of the telco ad on users who are not in a BT group of either the auto ad or the telco ad, Con_control_Adtargeted. The impact of targeting of the auto ad may then be measured or estimated using Equation 2, above.

While targeting is used as an example parameter, any of various other parameters may be assessed, measured, or estimated. Furthermore, regarding targeting, while BT is used as an example, any of the many different forms of targeting may be assessed, measured, or estimated.

While the invention is described with reference to the above drawings, the drawings are intended to be illustrative, and the invention contemplates other embodiments within the spirit of the invention.

1. A method comprising:
using one or more computers, without arranging for experimental events to occur, obtaining and storing online advertisement performance information for use in determining experimental results, comprising:
first data relating to performance of a first advertisement to users in a treatment group;
second data relating to performance of a second advertisement to users in the treatment group;
third data relating to performance of the first advertisement to users in a control group; and
fourth data relating to performance of the second advertisement to users in the control group;
wherein, with regard to a particular user-to-advertisement relationship, relative to the first advertisement, users in the treatment group are positive while users in the control group are neutral, while, relative to the second advertisement, users in the treatment group and users in the control group are neutral; and
using one or more computers, determining or estimating, and storing, information relating to an impact of positiveness of the relationship on performance of the first advertisement, comprising performing a difference-in-differences experimental technique utilizing the first, the second, the third, and the fourth data.

2. The method of claim 1, wherein the experimental technique comprising subtracting a first difference from a second difference, and wherein the first difference comprises a measure of performance of the first advertisement relative to users in the treatment group minus a measure of performance of the second advertisement relative to users in the treatment group, and wherein the second difference comprises a measure of performance of the first advertisement relative to users in the control group minus a measure of performance of the second advertisement relative to the control group.

3. The method of claim 1, wherein the relationship is a targeting relationship, and wherein positiveness in the relationship means that a user is targeted, and wherein neutralness in the relationship means that a user is untargeted.

4. The method of claim 1, wherein the relationship is a targeting relationship, and wherein positiveness in the relationship means that a user is targeted, and wherein neutralness in the relationship means that a user is untargeted, and wherein the targeting relationship comprises a behavioral targeting relationship.

5. The method of claim 1, wherein conversion rates are utilized in measuring performance.

6. The method of claim 1, wherein click through rates are utilized in measuring performance.

7. The method of claim 1, wherein a measure relating to user engagement comprising one or more offline and one or more online user engagements is utilized in measuring performance.

8. The method of claim 1, comprising using information in non-experimental events in online advertising to obtain experimental information from which one or more experimental results can be obtained.

9. The method of claim 1, comprising using information in non-experimental events in online advertising to obtain experimental information from which one or more experimental results can be obtained, and wherein the non-experimental events comprise one or more randomized displayed advertisements or one or more splits.

10. A system comprising:
one or more server computers coupled to a network; and
one or more databases coupled to the one or more server computers;
wherein the one or more server computers are for:
without arranging for experimental events to occur, obtaining and storing online advertisement performance information for use in determining experimental results, comprising:
first data relating to performance of a first advertisement to users in a treatment group;
second data relating to performance of a second advertisement to users in the treatment group;
third data relating to performance of the first advertisement to users in a control group; and
fourth data relating to performance of the second advertisement to users in the control group;
wherein, with regard to a particular user-to-advertisement relationship, relative to the first advertisement, users in the treatment group are positive while users in the control group are neutral, while, relative to the second advertisement, users in the treatment group and users in the control group are neutral; and
determining or estimating, and storing, information relating to, an impact of a positiveness of the relationship on performance of the first advertisement, comprising performing a difference-in-differences experimental technique utilizing the first, the second, the third, and the fourth data.

11. The system of claim 10, wherein at least one of the one or more server computers are coupled to an advertising exchange.

12. The system of claim 10, wherein the experimental technique comprising subtracting a first difference from a second difference, and wherein the first difference comprises a measure of performance of the first advertisement relative to users in the treatment group minus a measure of performance of the second advertisement relative to users in the treatment group, and wherein the second difference comprises a measure of performance of the first advertisement relative to users in the control group minus a measure of performance of the second advertisement relative to the control group.

13. The system of claim 10, wherein the relationship is a targeting relationship, and wherein positiveness in the relationship means that a user is targeted, and wherein neutralness in the relationship means that a user is untargeted.

14. The system of claim 10, wherein the relationship is a targeting relationship, and wherein positiveness in the relationship means that a user is targeted, and wherein neutralness in the relationship means that a user is untargeted, and wherein the targeting relationship comprises a behavioral targeting relationship.

15. The system of claim 10, wherein conversion rates are utilized in measuring performance.

16. The system of claim 10, wherein click through rates are utilized in measuring performance.

17. The system of claim 10, wherein a measure relating to user engagement is utilized in measuring performance.

18. The system of claim 10, comprising using information in non-experimental events in online advertising to obtain experimental information from which one or more experimental results can be obtained.

19. The system of claim 10, wherein the online advertisement performance information is relative to advertisement performance relating to advertisements served during a specified period of time.

20. A computer readable medium or media containing instructions for executing a method comprising:
using one or more computers, without arranging for experimental events to occur, obtaining and storing online advertisement performance information for use in determining experimental results, comprising:
first data relating to performance of a first advertisement to users in a treatment group;
second data relating to performance of a second advertisement to users in the treatment group;
third data relating to performance of the first advertisement to users in a control group; and
fourth data relating to performance of the second advertisement to users in the control group;
wherein, with regard to an advertisement targeting relationship, relative to the first advertisement, users in the treatment group are positive while users in the control group are neutral, while, relative to the second advertisement, users in the treatment group and users in the control group are neutral; and
using one or more computers, determining or estimating, and storing, information relating to, an impact of targeting on performance of the first advertisement, comprising performing a difference-in-differences experimental technique utilizing the first, the second, the third, and the fourth data, wherein technique comprises subtracting a first difference from a second difference, wherein the first difference comprises a measure of performance of the first advertisement relative to users in the treatment group minus a measure of performance of the second advertisement relative to users in the treatment group, and wherein the second difference comprises a measure of performance of the first advertisement relative to users in the control group minus a measure of performance of the second advertisement relative to the control group.
